(19) United States
(12) Patent Application Publication
(10) Pub. No.: US 2026/0183781 A1
(43) Pub. Date: Jul. 2, 2026

(54) DEVICE FOR DISPENSING A FLUID PRODUCT, COMPRISING A PUMP

(71) Applicant: APTAR FRANCE SAS, LE NEUBOURG (FR)

(72) Inventor: Dominique BRUNET, BARC (FR)

(73) Assignee: APTAR FRANCE SAS, LE NEUBOURG (FR)

(21) Appl. No.: 19/130,370

(22) PCT Filed: Nov. 14, 2023
(86) PCT No.: PCT/FR2023/051787

§ 371 Date: May 15, 2025

(30) Foreign Application Priority Data
Nov. 16, 2022 (FR) FR2211914

(51) Int. Cl. B05B 11/10

(52) U.S. Cl. CPC B05B 11/1047; B05B 11/1001

(57) ABSTRACT

A device for dispensing a fluid product, having a pump having a pump body attached to a neck of a reservoir containing a fluid product to be dispensed, the neck having an upper axial edge, a compression element being arranged on the upper axial edge, the pump having a turret, the turret having an attachment portion for direct attachment to the pump body, a compression portion for compressing the compression element on the upper axial edge of the neck, and a fitting sleeve extending axially downwards under the compression portion, the fitting sleeve fitting into the neck of the reservoir during the assembly of the pump on the reservoir, the fitting sleeve having at least one radial sealing profile which, after assembly, sealingly engages with the neck of the reservoir.

The present invention relates to a device for dispensing a fluid product comprising a pump.

A conventional pump comprises a pump body defining a pump chamber, with at least one piston sliding in said pump body to dispense a dose of a fluid product contained in a reservoir to which the pump is attached. The pump is attached to the neck of a reservoir by means of an attachment ring, and generally comprises a turret, which is an element attached to the pump body and which comes into contact with a neck seal provided to ensure sealing at the neck of the reservoir.

A drawback of this type of pump is that it can occur that the fluid product comes into contact with the neck seal, likely in particular to absorb part of the fluid.

The present invention aims to provide a device for dispensing a fluid product which does not reproduce the above-mentioned drawbacks.

Another object of the present invention is to provide a device for dispensing a fluid product that reduces the risks of absorption of the fluid product by a neck seal.

Another object of the present invention is to provide such a device for dispensing a fluid product that allows manufacturing tolerances to be relatively large.

Another object of the present invention is to provide a device for dispensing a fluid product that is simple and inexpensive to manufacture and to assemble and reliable to use, while guaranteeing perfect sealing.

The present invention thus relates to a device for dispensing a fluid product, comprising a pump having a pump body attached to a neck of a reservoir containing a fluid product to be dispensed, said neck comprising an upper axial edge, a compression element being arranged on said upper axial edge, said pump comprising a turret, said turret comprising an attachment portion for attachment to said pump body, a compression portion for compressing said compression element on said upper axial edge of said neck, and a fitting sleeve extending axially downwards under said compression portion, said fitting sleeve fitting into said neck of said reservoir during the assembly of said pump on said reservoir, said fitting sleeve comprising at least one radial sealing profile which, after assembly, sealingly engages with said neck of said reservoir.

Advantageously, each radial sealing profile is formed by a peripheral sealing bead.

According to a first advantageous embodiment, said fitting sleeve comprises a single radial sealing profile.

According to a second advantageous embodiment, said fitting sleeve comprises at least two radial sealing profiles, offset axially.

According to a first advantageous variant, said compression element is made in the form of a neck seal.

According to a second advantageous variant, said compression element is formed by a deformable lip secured to said turret.

Advantageously, said compression portion is formed by a radial annular wall of said turret.

Advantageously, said turret is a one-piece part which is attached directly to said pump body, which is suitable for engaging directly with said compression element to compress it on said upper axial edge of said neck, and which is suitable for engaging directly with the inside of said neck.

These characteristics and advantages of the present invention, and others, appear more clearly from the following detailed description, given by way of non-limiting example, and with reference to the accompanying drawings, in which:

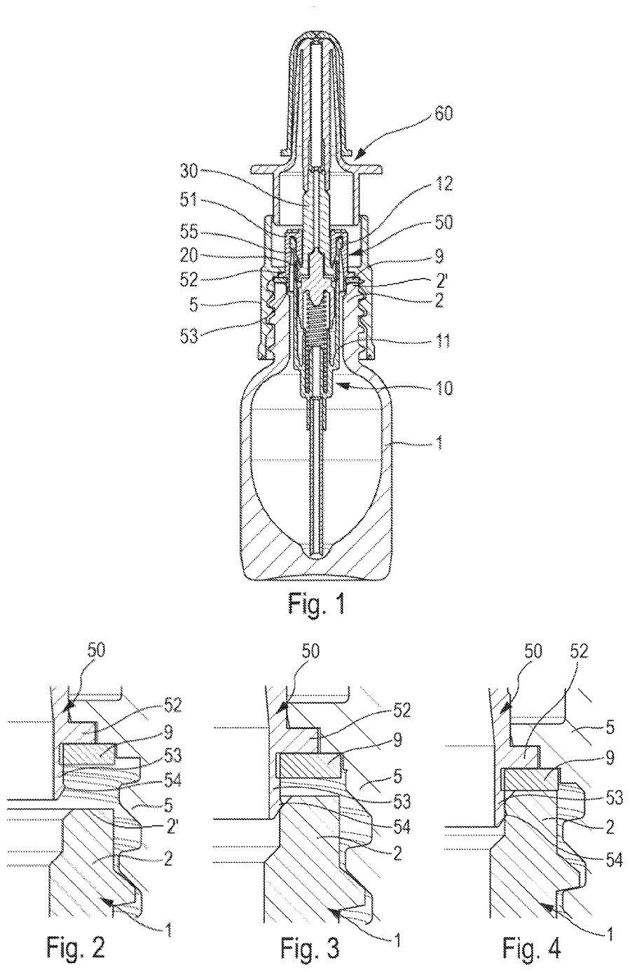

FIG. 1 is a schematic, cross-sectional view of a device for dispensing a fluid product comprising a pump,

FIGS. 2 to 4 are schematic sectional views, showing in detail the neck of the reservoir, the turret and the attachment ring, during the assembly of the pump on the reservoir, according to a first advantageous embodiment,

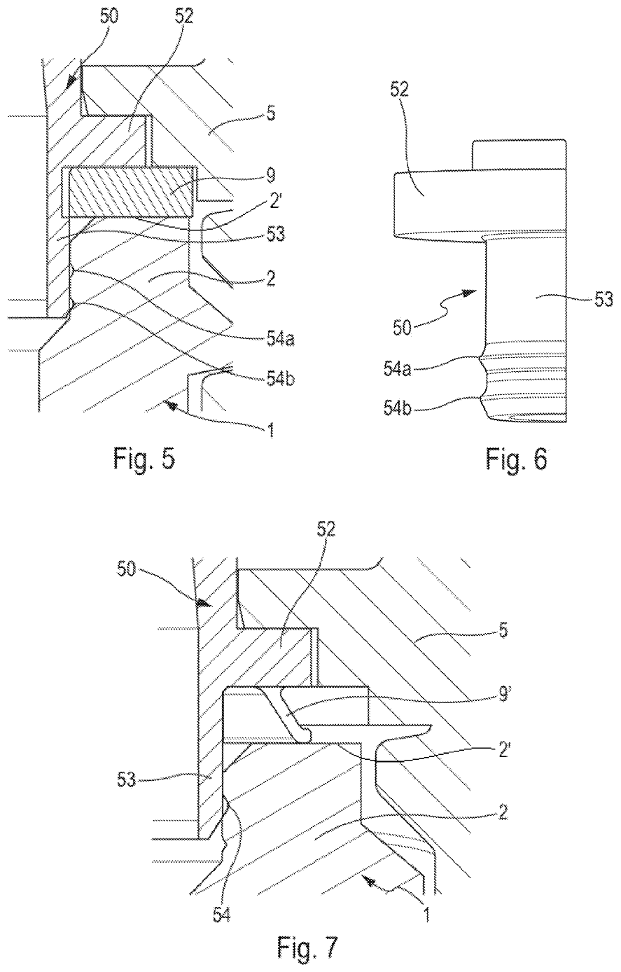

FIG. 5 is a view similar to the view in FIG. 4, showing a second advantageous embodiment;

FIG. 6 is a cut-out schematic perspective view of the turret of FIG. 5, and

FIG. 7 is a view similar to the view in FIG. 4, showing a second advantageous embodiment;

The terms “axial” and “radial” are relative to the longitudinal central axis of the device. The terms “top”, “bottom”, “upper” and “lower” refer to the upright position of the device shown in FIG. 1.

The following description will be made with reference to three embodiments, but it is understood that other variants are possible.

In the first embodiment, represented in FIGS. 1 to 4, a device for dispensing a fluid product of a conventional type is shown.

The device comprises a reservoir 1 provided with a neck 2, a pump 10 being assembled on said neck 2 of the reservoir 1 by means of an attachment ring 5, with the interposition of a compression element 9, useful for compensating for the dimensional tolerances of the parts and thus ensuring reliable attachment in all circumstances.

In the examples of FIGS. 1 to 5, the compression element is a neck seal 9 arranged on an upper axial edge 2′ of the neck 2 of the reservoir 1. In the example of FIG. 7, the compression element is a deformable lip 9′, secured with the turret 50, and which engages with said upper axial edge 2′.

The pump includes a pump body 11 provided with an upper end edge 12. A piston 20 slides in leaktight manner inside said pump body 11 on each actuation, so as to dispense a dose of composition from the reservoir 1.

The internal structure of the pump is not described in greater detail below, since the present invention applies to any type of pump, and is not limited in any way by the specific characteristics of the pump given by way of example in Figures.

In conventional manner, the piston 20 is secured, in particular integrally, as shown in the drawings, with an actuator rod 30 on which there is assembled a dispenser head or pusher on which the user presses so as to actuate the pump.

The pump body 11, in particular its upper end edge 12 is fixed in a turret 50 at an attachment portion 51 of said turret.

The turret 50 also comprises a compression portion 52, preferably formed by a radial annular wall, which engages during assembly with the compression element 9 which is interposed between the upper edge of the neck 2 and said compression portion 52.

The turret 50 comprises a fitting sleeve 53 extending axially downwards under said compression portion 52, said fitting sleeve 53 fitting during assembly into the axially upper part of the neck 2 of the reservoir 1.

The turret 50 therefore forms a one-piece part which on the one hand is attached directly to the pump body 11, which on the other hand engages directly with the compression element 9, 9′ to compress it on the upper axial edge 2′ of the neck 2, and which finally engages directly with the inside of said neck 2 of the reservoir 1.

The turret 50 is advantageously made by moulding with a suitable plastic material.

A ferrule 55 is assembled inside the pump body 11, and co-operates with the piston 20 so as to define the rest position of said piston.

In the example of FIG. 1, the ferrule 55 is formed in one piece with the turret 50.

According to the invention, the fitting sleeve 53 comprises at least one radial sealing profile 54 which sealingly engages with the neck 2 of the reservoir 1.

In the example of FIGS. 2 to 4 and 7, there is a single radial sealing profile 54, advantageously formed by a peripheral sealing bead.

In the example of FIGS. 5 and 6, there are two radial sealing profiles 54a, 54b axially offset on said sealing sleeve 53, advantageously each formed by a peripheral sealing bead.

Naturally, any number of sealing profiles 54 could be provided.

This at least one sealing profile 54 creates a sealed contact with the inside of the neck 2 of the reservoir 1, so it is no longer necessary to provide a neck seal, which is therefore replaced here by the compression element 9.

Of course, this compression element 9 can be made in the form of a neck seal, as in the examples in FIGS. 1 to 5.

Alternatively, it may be formed by a deformable lip 9′, secured with the turret 50, and which engages with the upper axial edge 2′ of the neck 2 of the reservoir 1, as can be seen in FIG. 7.

An essential advantage of the present invention is that any risk of contact between the fluid product contained in the reservoir 1 and a neck seal likely to absorb fluid is avoided by the presence of the at least one radial sealing profile 54.

Although the present invention is described above with reference to particular embodiments thereof, the description is naturally non-limiting, and any useful modification could be applied thereto by a person skilled in the art, without going beyond the ambit of the present invention, as defined by the accompanying claims.

1-8. (canceled)

9. A device for dispensing a fluid product comprising a pump having a pump body attached to a neck of a reservoir, said reservoir containing a fluid product to be dispensed and comprising a closed bottom opposite to said neck, a compression element being arranged on said upper axial edge of said neck furthest from the bottom of the reservoir, said pump comprising a turret, said turret comprising an attachment portion for direct attachment to said pump body, a compression portion for compressing said compression element on said upper axial edge of said neck, and a fitting sleeve extending axially downwards under said compression portion, said fitting sleeve fitting into said neck of said reservoir during the assembly of said pump on said reservoir, characterised in that said fitting sleeve comprises at least one radial sealing profile which, after assembly, sealingly engages with said neck of said reservoir.

10. The device according to claim 9, wherein each radial sealing profile is formed by a peripheral sealing bead.

11. The device according to claim 9, wherein said fitting sleeve comprises a single radial sealing profile.

12. The device according to claim 9, wherein said fitting sleeve comprises at least two axially offset radial sealing profiles.

13. The device according to claim 9, wherein said compression element is made in the form of a neck seal.

14. The device according to claim 9, wherein said compression element is formed by a deformable lip, secured with said turret.

15. The device according to claim 9, wherein said compression portion is formed by a radial annular wall of said turret.

16. The device according to claim 9, wherein said turret is a one-piece part which is attached directly to said pump body, which is suitable to engage directly with said compression element to compress it on said upper axial edge of said neck, and which is adapted to engage directly with the inside of said neck.
